(19) United States
(12) Patent Application Publication
(10) Pub. No.: US 2026/0278445 A1
(43) Pub. Date: Sep. 17, 2026

(54) Characterization Of Quantum Processors via Density-Matrix-Renormalization-Group Methods

(71) Applicant: Google LLC, Mountain View, CA (US)

(72) Inventors: Sofia Gonzalez Garcia, Santa Barbara, CA (US); Agustin Di Paolo, Santa Barbara, CA (US); Aaron Miklos Strimling Szasz, Santa Barbata, CA (US); Dvir Kafri, Goleta, CA (US); Guifre Vidal Bonafont, Santa Barbara, CA (US)

(21) Appl. No.: 19/235,391

(22) Filed: Jun. 11, 2025

Related U.S. Application Data
(60) Provisional application No. 63/772,375, filed on Mar. 14, 2025.

(51) Int. Cl. G06N 10/60; G06N 10/70

(52) U.S. Cl. CPC G06N 10/60; G06N 10/70

(57) ABSTRACT

One example aspect of the present disclosure is directed to a method for quantum computing. The method includes performing a variational algorithm to determine a set of eigenstates of a Hamiltonian. The Hamiltonian corresponds to a quantum processor. The method includes characterizing the quantum processor based on the set of eigenstates

### PRIORITY

This application claims priority to U.S. Provisional Application No. 63/772,375 entitled CHARACTERIZATION OF QUANTUM PROCESSORS VIA DENSITY-MATRIX-RENORMALIZATION-GROUP METHODS, filed on Mar. 14, 2025, the contents of which of herein incorporated in their entirety.

### FIELD

The present disclosure relates generally to quantum computing and information processing systems, and more particularly to the characterization of quantum processors via density-matrix-renormalization-group methods.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b | 1 [symbol] The “0” and “1” states of a digital computer are analogous to the |0 [symbol] and | 1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for quantum computing. The method includes performing a variational algorithm to determine a set of eigenstates of a Hamiltonian. The Hamiltonian corresponds to a quantum processor. The method includes characterizing the quantum processor based on the set of eigenstates.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2A shows a schematic view of a device layout and a device model for a quantum processor, according to various embodiments.

FIG. 2B shows a schematic view of modeled interactions of the device model of FIG. 2A and a device Hamiltonian based on the modeled interactions, according to various embodiments.

FIG. 3A shows an eigenstate estimator pipeline, according to various embodiments.

FIG. 3B shows a representation of a wavefunction tensor as a matrix product state 330, according to various embodiments.

FIG. 4 shows an example of representing a 2D device as a 1D spin chain, according to various embodiments.

FIG. 5A shows a tensor network diagram depicting a multi-target matric product state and a tensor network diagram depicting an ansatz for a density matrix renormalization group algorithm, according to various embodiments.

FIG. 5B shows a tensor network diagram depicting a 2-site effective Hamiltonian and a construction of a 2-site multi-target state, according to various embodiments.

### DETAILED DESCRIPTION

The embodiments are directed to methods, processes, operations, protocols, and procedures for characterizing a quantum processor that includes qubits and qubit couplers. The qubits and qubit couplers (referred to as quantum devices) may be arranged in a 2D array of quantum devices. The 2D array of qubit devices may be “unraveled” into a 1D “spin chain,” where each “site” in the spin chain corresponds to a separate qubit or qubit coupler. More particularly, the embodiments include determining “dressed” eigenstates and “dressed” eigenvalue for a device Hamiltonian that corresponds to the qubit/qubit coupler system. A device model for the system of qubits/qubit couplers is employed to determine the Hamiltonian for a quantum processor. The device model includes interactions and/or couplings (e.g., capacitive couplings) between the quantum devices.

More specifically, the device Hamiltonian includes “single-site” terms as well as interaction terms corresponding to the various interactions of the qubits and couplers included in the device model. Thus, the eigenstates of the device Hamiltonian are “dressed” eigenstates. A dressed eigenstate may be a “hybridized” state of the qubits and couplers. For instance, a dressed eigenstate may include the “spread” of an excitation to a single quantum device (e.g., a qubit or a qubit coupler) to neighboring quantum devices. The embodiments employ a variational method to determine and/or estimate dressed eigenstates of the device Hamiltonian.

Such variational methods include, but are not limited to, a density matrix renormalization group (DMRG) algorithm or one or more variants of a DMRG algorithm. For instance, the dressed eigenstates of a quantum processor may be determined via a DMRG algorithm applied to the device Hamiltonian. Such a DMRG algorithm targets a single eigenstate of the device Hamiltonian. In some embodiments, a DMRG-variant that is multi-target DMRG (MTDMRG) algorithm is employed. As employed by the embodiments, a MTDMRG algorithm targets multiple dressed eigenstates of the device Hamiltonian. The embodiments also include the employment of another variant in the family of DMRG-variants, referred to as a DMRG-X algorithm. A DMRG-X algorithm targets a single excited many body localization (MBL) eigenstate of the device Hamiltonian. The embodiments include still another new development in the family of DMRG-variants: a multi-target DMRG-X (MTDMRG-X), which targets multiple excited MBL eigenstates. The MTDMRG-X algorithm includes a novel combination of the DMRG-X and the MTDMRG algorithms.

More specifically, the embodiments include a novel adaptation of the DMRG algorithm (i.e., the MTDMRG-X algorithm) for targeting several particular excited states of interest simultaneously. The novel technique combines the multi-target DMRG (MTDMRG) algorithm and DMRG-X. As noted above, the DMRG-X algorithm includes a method to target excited MBL eigenstates. The MTDMRG-X algorithm allows the targeting of excited states without the need of pre-computing the lower part of the spectrum. The MTDMRG-X algorithm has the significant advantage that this method is robust even for resolving excited states where strong hybridization is present. The MTDMRG-X algorithm is naturally parallelized for efficient large-scale calculations. Some embodiments employ the MTDMRG-X algorithm to a two-dimensional transmon chip array.

As noted above, the embodiments include characterizing a quantum processor by determining (or estimating) the dressed eigenstates by the DMRG algorithm, or a variant of the DMRG algorithm in a family of DMRG-variants. Characterizing a quantum processor includes characterizing the cross-talk and longer-range couplings in the quantum devices (e.g., qubits and qubit couplers). Characterizing a quantum processor may include at least one od identifying safe device-operations regimes with low spectator errors, determining a convergence of multi-qubit convergence theory, and mitigating errors by circuit design. Some embodiments include operating a quantum computing system (QCS) based on the characterization of the quantum processor included in the QCS.

One method includes performing a density-matrix-renormalization-group (DMRG) algorithm. Performing the DMRG algorithm enables determining a set of a set of eigenstates of a Hamiltonian. The Hamiltonian corresponds to a quantum processor. The quantum processor is characterized based on the set of eigenstates.

Designing a large-scale superconducting processor is a technically difficult task because it requires solving the Schrödinger equation for a large number of interacting quantum systems (in one particular case, transmon qubits). Solving this problem on a classical machine and in a numerically exact way requires time and memory resources that scale exponentially with the number of quantum degrees of freedom in consideration (i.e., the number of qubits plus couplers and readout/reset resonators in the chip). The exact solution is thus limited to a relatively small number of degrees of freedom O(10), while some quantum computers allocate hundreds of them in practice. In this context, matrix product states are a phenomenal mathematical tool for encoding solutions of the Schrodinger equation by allowing for an efficient way of truncating the state's representation such that memory and runtime resources scale polynomially with system size, instead of exponentially. To that end, the embodiments include methods for targeting highly excited states of a quantum processor device (e.g., a superconducting quantum processor device) with 100s of degrees of freedom. The embodiments facilitate the effective design of large-scale superconducting quantum processors and the analysis of error modes at such scales.

Briefly here, the embodiments include novel updates of the-density-matrix-renormalization-group (DMRG) algorithm. The DMRG algorithms of the embodiments targeting several particular excited states of interest simultaneously. The embodiments combine a multi-target DMRG (MTDMRG) algorithm and a DMRG-X (a method developed to target excited MBL eigenstates) algorithm to generate a multi-target DMRG-X algorithm (e.g., a MTDMRG-X algorithm). The MTDMRG-X algorithm (or any of the other DMRG algorithms or DMRG-variant algorithms) may be employed to determine (or estimate) at least some of the dressed (or hybridized) eigenstates of a qubit/qubit coupler array (e.g., a 1D or 2D arrays of qubits and qubit couplers) included in a quantum processor as discussed herein. The quantum processor may be characterized via the determined dressed eigenstates.

One example aspect of the present disclosure is directed to a method for quantum computing. The method includes performing a variational algorithm to determine a set of eigenstates of a Hamiltonian. The Hamiltonian corresponds to a quantum processor. The method includes characterizing the quantum processor based on the set of eigenstates. The method may include operating a quantum computing systems (QCS) that includes the quantum processor. The OCS may be operated in accordance with the characterization of the quantum processor and/or the determined eigenstates. Operating the QCS in accordance with the characterization of the quantum processor and/or its dressed eigenstates includes implementing a quantum error correction (QEC) code, such as but not limited to a surface code, a color code, and a Shor QEC code. In some embodiments, operating a QCS and/or implementing a QEC code may include measuring one or more qubits (e.g., measure qubits in the QEC code).

Aspects of the present disclosure provide a number of technical effects and benefits. For instance, the embodiments allow the targeting of excited states without the need of pre-computing the lower part of the spectrum, with the significant advantage that this method is robust even for resolving excited states where strong hybridization is present. This algorithm is naturally parallelized for efficient large-scale calculations. The embodiments have enabled the successfully the successful characterization of quantum processors that include 1D and 2D qubit/coupler arrays (e.g., transmon qubits and couplers).

### Quantum Computing Systems

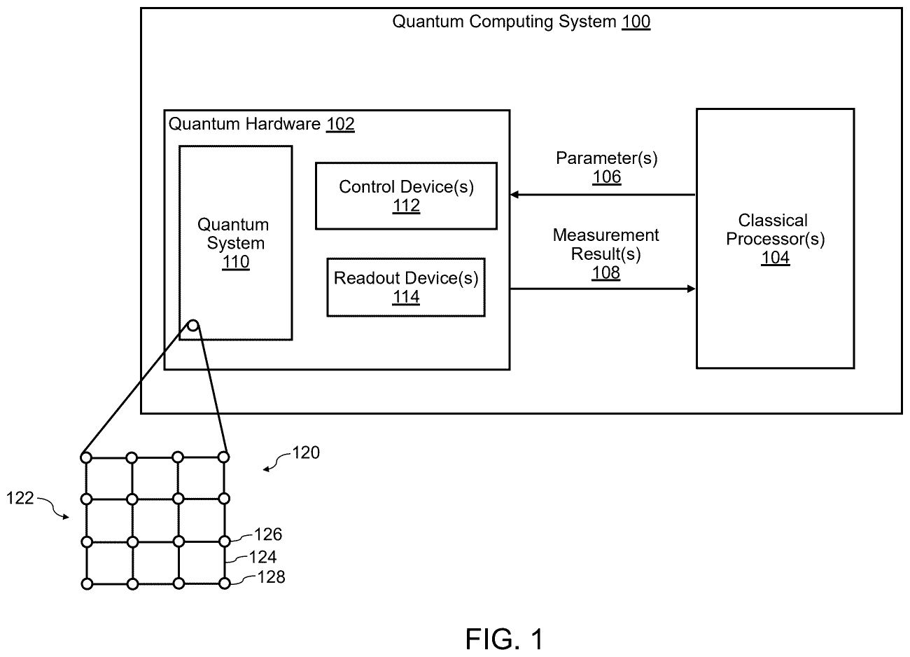

The system 100 includes quantum hardware 102 in data communication with one or more classical processors 104. The classical processors 104 can be configured to execute computer-readable instructions stored in one or more memory devices to perform operations, such as any of the operations described FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like. In some implementations, the superconducting qubits may be located in a cryostat to cool the qubits to superconducting temperatures (e.g., less than about 3 Kelvin). However, aspects of the present disclosure are not limited to superconducting qubits. In some examples, any suitable qubit structure may be used without deviating from the scope of the present disclosure, such as photonic qubits, trapped ion qubits, spin qubits, neutral atom qubits, quantum dot qubits, molecular qubits, or other qubits.

The type of multi-level quantum subsystems that the system 100 utilizes may vary. For example, in some cases the system may include one or more readout device(s) 114 coupled (e.g., electromagnetically coupled) to one or more qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dot, or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to control the qubits. For example, in some implementations the multi-level quantum subsystems may be neutral atom qubits and the control devices 112 may be configured to provide control pulses to control lines to generate magnetic fields to control the qubits.

The quantum hardware 102 may further include readout devices 114 (e.g., readout resonators). Measurement results 108 obtained via readout devices 114 may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. The readout device(s) 114 may be configured to perform quantum measurements on the quantum system 110 and send measurement results 108 to the classical processors 104.

In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state | 1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed. In some examples, the operating of the frequencies for the qubits 120 may be adjusted using AC Stark shift according to examples of the present disclosure before a quantum computation, quantum gate, and/or a quantum algorithm is performed.

FIG. 1 depicts one example quantum computing system that can be used to implement the methods and operations according to example aspects of the present disclosure. Other quantum computing systems can be used without deviating from the scope of the present disclosure.

### Quantum Processor

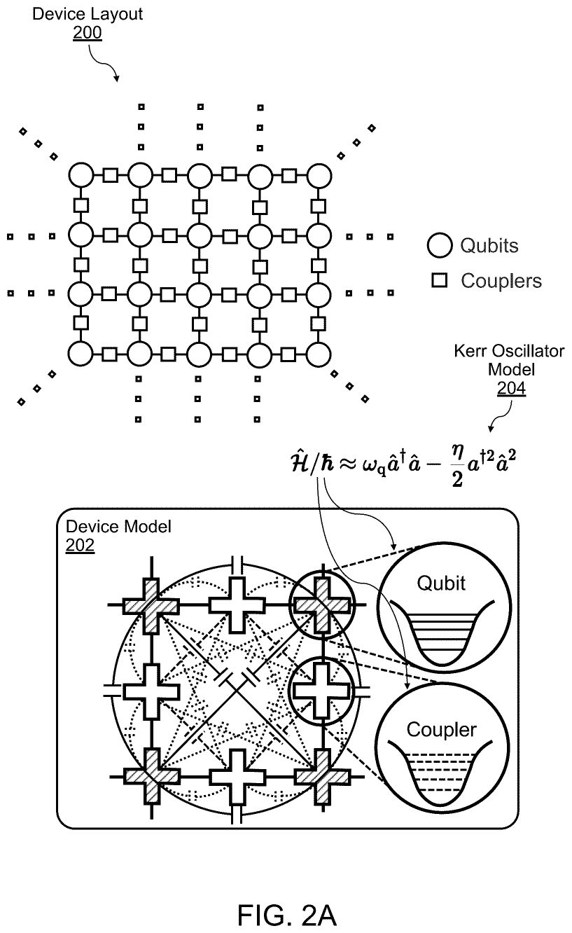

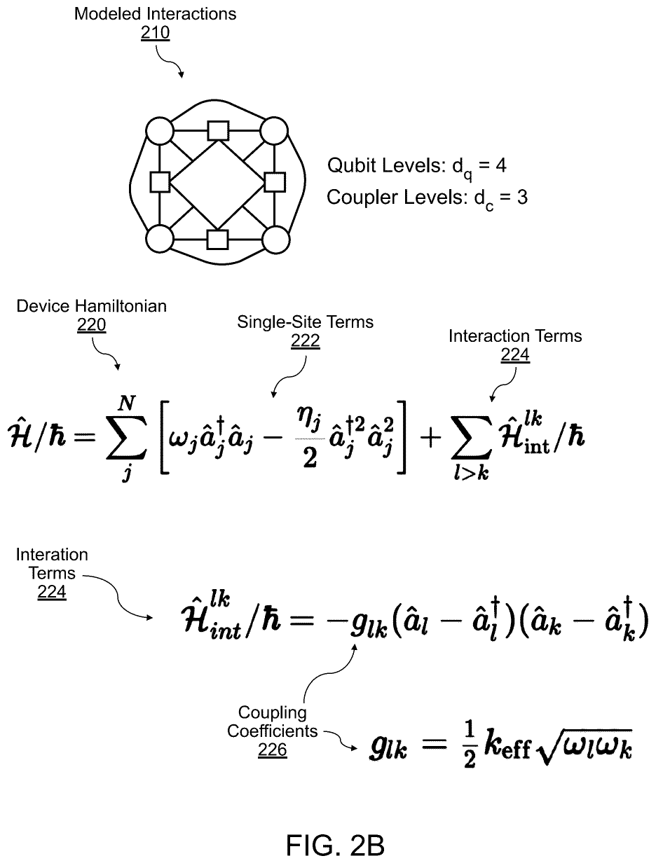

FIG. 2A shows a schematic view of a device layout 200 and a device model 202 for a quantum processor, according to various embodiments. The quantum processor and the device layout 200 for the quantum processor may be included in quantum hardware, such as but not limited to quantum hardware 102 of FIG. 1. As shown in FIG. 2A, the device layout 200 includes a 2D array of qubits and qubit couplers. Note that each qubit coupler couples two nearest neighbor qubits such that each qubit is coupled to its four nearest neighboring qubits via four separate couplers (e.g., neglecting boundary or edge qubits and couplers).

The embodiments characterize such a quantum processor via modeling the device. More specifically, a Hamiltonian for the quantum processor (e.g., a device Hamiltonian) that models the devices is determined. The “dressed” eigenstates and corresponding “dressed” eigenvalues (e.g., energy levels) for the device Hamiltonian are determined via variational methods (e.g., density matrix renormalization (DMRG) algorithms). The device model 202 is employed to determine the device Hamiltonian. To be relevant, the device model 202 may include interactions (e.g., capacitive couplings) between the qubits and couplers. As used herein, the term “quantum device” may be employed to refer to individual and/or multiple qubits and/or couplers.

An isolated qubit or coupler may be approximated as a quantum harmonic oscillator (QHO). In some embodiments, a Kerr-oscillator model 204 may be employed to model an isolated quantum device (e.g., an isolated qubit and/or an isolated coupler). The Kerr oscillator model 204 includes parameterized frequency (transition frequencies) parameters (e.g., w) and Kerr coefficients (e.g., n) (or Kerr parameters). The Kerr oscillator models 204 includes a Hamiltonian with “bare” eigenstates and eigenvectors that are approximately those of a QHO, as shown in the device model. That is, a coupler and a qubit may be approximated as a quantum harmonic oscillator with quantized states, including a ground state and multiple excited states. The ground state and the first excited state are the “computational” states, while the higher excited states are referred to as “leakage” states. In various embodiments, the Kerr oscillator model 204 includes single-site terms (e.g., see single-site terms 222 of FIG. 2B). That is, the Hamiltonian of the Kerr oscillator model 204 may be employed to provide single site terms for a device Hamiltonian (e.g., see device Hamiltonian 220 of FIG. 2B). As shown in FIG. 2A, the device model 202 includes interactions (e.g., capacitive couplings) between neighboring qubits and/or couplers. Note that the qubit and coupler states shown in the device model 202 are “bare” states, which are distinguished from “dressed” or “hybridized” states discussed below.

FIG. 2B shows a schematic view of modeled interactions 210 of the device model 202 of FIG. 2A and a device Hamiltonian 220 based on the modeled interactions 210, according to various embodiments. The device Hamiltonian 220 includes terms (e.g., interaction terms 224) corresponding to the qubit/coupler interactions as shown in modeled interactions 210. As such, the device Hamiltonian 220 includes single-site terms 222 for the qubits and interaction terms 224 between the qubits and the couplers. The single-site terms 222 include a sum (over the individual qubits and couplers) of the Hamiltonian of the Kerr oscillator model 204 of FIG. 2B. As shown in the modeled interactions 210, when modeling the device, four qubit states and three coupler states are included in the model. In other embodiments, higher order leakage (or excited) states for both qubits and couplers may be considered. The interactions 224 terms include coupling coefficients 226 encoded in the 2-rank tensor gₗₖ.

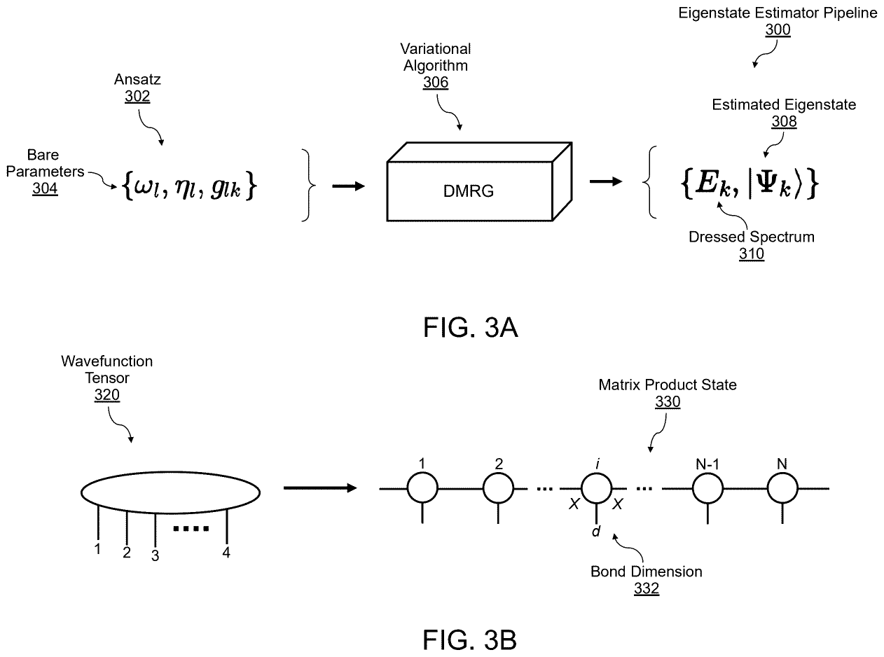

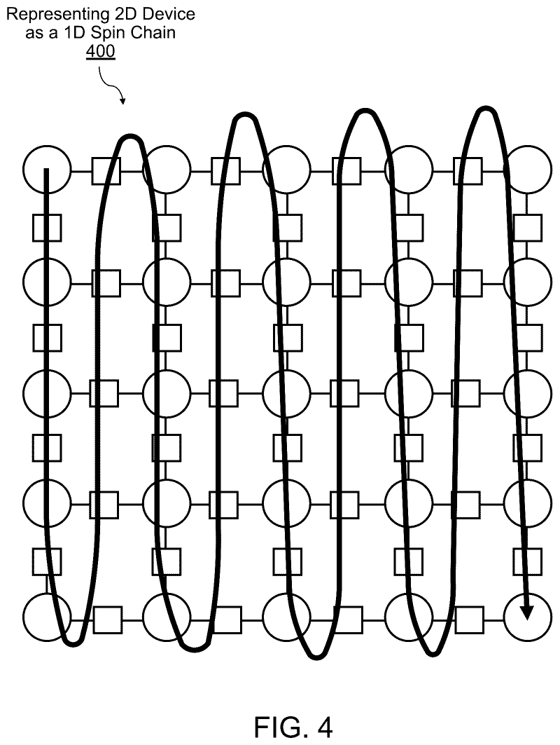

A bare eigenstate of a qubit and/or a coupler in a 2D array (e.g., device layout 200 of FIG. 2A) represents the quantum state of that qubit (or coupler) if it were completely isolated from all other qubits and coupling elements (e.g., a coupler) in the array. In this idealized scenario, the qubit's energy levels and the corresponding eigenstates (typically the |0 [symbol] and |1 [symbol] states in the computational basis) are determined solely by its intrinsic properties and any externally applied control fields acting specifically on that qubit. A bare state may be characterized by a set of bare parameters (e.g., bare parameters 304 of FIG. 3). Note that the bare parameters may include transition frequencies (ωₗ), Kerr parameters (ηₗ), and coupling coefficients (or parameters) (gₗₖ). The bare frequencies are the frequencies associated with transitions between these bare eigenstates. These are fundamental properties of the individual qubit when its environment (consisting of the other qubits and couplers included in the device layout 200 of FIG. 2B) is effectively “turned off” or decoupled.

In contrast, a dressed eigenstate describes the state of a qubit and/or coupler when it is interacting with its neighbors and the surrounding quantum environment, including the coupling elements in the array. In a 2D array of qubits with tunable couplers (e.g., device layout 200 of FIG. 2B), the interaction between qubits and between qubits and couplers modifies the energy levels (e.g., eigenvalues) and eigenstates of the individual qubits. The eigenstates become “dressed” by the influence of these interactions, meaning they are no longer simple superpositions of the bare |0 [symbol] > and |1> states but are instead mixed states involving the excitations of neighboring qubits and couplers. The frequencies associated with transitions between these dressed eigenstates are the dressed frequencies. These frequencies are not intrinsic properties of the individual qubits alone but are collective properties of the interacting system. They depend on the strength and nature of the couplings, as well as the bare frequencies of all interacting elements. In the context of characterizing a quantum processor, the embodiments solve for the “dressed” eigenstates (and corresponding “dressed” energy levels), which are the eigenstates of the device Hamiltonian 220, which includes the interaction terms 224. The dressed eigenstates may be characterized via a dressed spectrum (e.g., dressed spectrum 310 of FIG. 3). To then understand the underlying physics and enable accurate control of the full multi-qubit/coupler system, these determined dressed quantities may be converted back to the bare quantities (e.g., bare parameters) that represent the intrinsic properties of the individual qubits and couplers before interactions are fully engaged. This conversion typically requires a detailed device model (e.g., device model 202 of FIG. 2A) that accounts for all relevant interactions within the array. and relates to quantum simulations.

FIG. 3A shows an eigenstate estimator pipeline 300, according to various embodiments. The embodiments may use the eigenstate estimator pipeline 300 to estimate the “dressed” eigenstates (and corresponding dressed energy levels) of the device Hamiltonian 220 of FIG. 2B. As noted throughout, the dressed eigenstates (and corresponding dressed energy levels) may be employed to characterize a quantum processor. The input to the eigenstate estimator pipeline 300 is an ansatz 302 that is characterized by bare parameters 304. The ansatz 302 is a parameterized “initial guess” of the eigenstates of the device Hamiltonian 220. The ansatz 302 is parameterized by the bare parameters 304. As discussed above, the bare parameters 304 may include may include transition frequencies (ωₗ), Kerr parameters (ηₗ), and coupling coefficients (or parameters) (gₗₖ). For instance, the ansatz 302 may include the bare eigenstates and/or the eigenstates to the single-site terms 222 of FIG. 2B or the Kerr oscillator model 204 of FIG. 2A.

The eigenstate estimator pipeline 300 includes a variational algorithm 306. More specifically, the ansatz 302 is provided as input, to the variational algorithm 306. Briefly, a variational algorithm, in the context of the embodiments, refers to a hybrid quantum-classical algorithm designed to find approximate solutions to computational problems, particularly suitable for characterizing a quantum processor. For instance, the variational algorithm may be employed to estimate eigenstates and an upper bound for the ground states of a Hamiltonian (e.g., device Hamiltonian 220 of FIG. 2B).

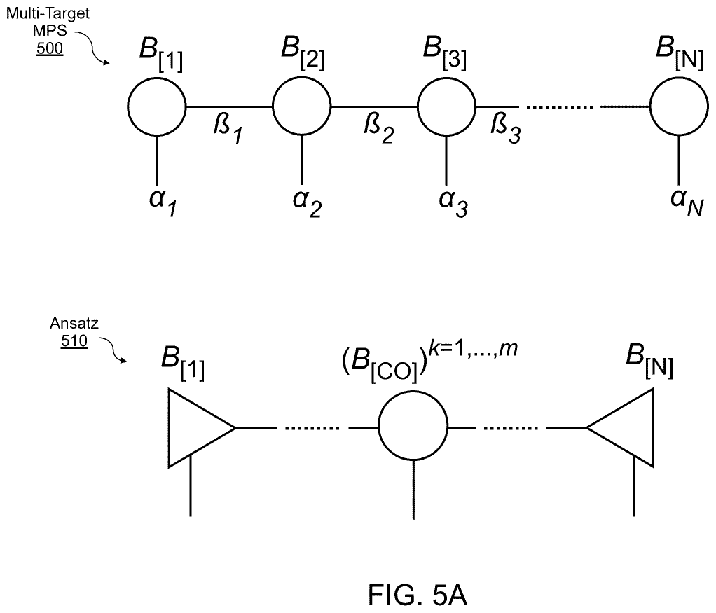

In various embodiments, the variational algorithm 306 may include a density matrix renormalization group (DMRG) algorithm (or a variant thereof in a family of DMRG-variants DMRG variant). A DMRG algorithm is an embodiment of numerical variational algorithms that are employed by the various embodiments for obtaining highly accurate low-energy eigenstates of quantum many-body systems, particularly one-dimensional systems. It operates by iteratively adding sites to a small, exactly solvable system, keeping only the most important states (those with the highest entanglement) at each step to manage the exponential growth of the Hilbert space. The method relies on the singular value decomposition (SVD) of the density matrix of a block of the system, projecting the Hamiltonian onto a reduced basis of these dominant states. This approach allows for the efficient calculation of ground state properties and low-lying excitations, making it a powerful tool for studying strongly correlated electron systems and quantum spin chains. As shown in FIG. 4, a 2D layout of qubits and couplers (e.g., device layout 200 of FIG. 2) may be modeled as a 1D spin chain, of which the dressed eigenstates (and corresponding energy levels) may be estimated via the eigenstate estimator pipeline.

FIG. 3B shows a representation of a wavefunction tensor 320 as a matrix product state 330, according to various embodiments. Many-body quantum states, such as those representing the wave function of a quantum system (e.g., the eigenstates of the device Hamiltonian 220 of FIG. 2B), can be challenging to characterize directly due to the exponential growth of their Hilbert space with the number of particles (e.g., qubits and couplers). A wave function that is described by a N-rank tensor (e.g., wavefunction tensor 320) with an index for each site (e.g., and individual qubit or coupler) can be more efficiently represented by a matrix product state (MPS) (e.g., MPS 330) in cases where the entanglement in the system is constrained, typically scaling only with the bond dimension (e.g., bond dimension 332) and not the system size. This representation factorizes the high-dimensional wave function tensor 320 into a product of lower-rank tensors (matrices), one for each qubit/coupler in the MPS 330. Note that an edge connecting two nodes (or sites) in MPS 330 is summed over.

Specifically, for a quantum state of N qubits and couplers,

$$\vert ψ 〉 = {\sum }_{{i}_{1} , {i}_{2} , … , {i}_{N}} {C}_{{i}_{1} , {i}_{2} , … , {i}_{N}} \vert {i}_{1} , {i}_{2} , … {i}_{N} 〉$$

where iₖ∈{0,1} denotes the state of the k-th qubit, the wave function coefficients form a rank-N tensor Cᵢ_{₁}ᵢ_{₂}_{. . . 1}_{ₙ} (e.g., wavefunction tensor 320).

In an MPS representation (e.g., MPS 330), this tensor (e.g., wavefunction tensor 320) is decomposed as:

$${C}_{{i}_{1} , {i}_{2} , {…i}_{N}} = {\sum }_{{α}_{0} , … , {α}_{N}} {M}_{1}^{{i}_{1}} ( {α}_{0} , {α}_{1} ) {M}_{2}^{{i}_{2}} ( {α}_{1} , {α}_{2} ) … {M}_{N}^{{i}_{N}} ( {α}_{N - 1} , {α}_{N} )$$

### (e.g., MPS 330). Here,

$${M}_{k}^{{i}_{k}}$$

are matrices (or tensors for more complex cases) associated with each site (qubit or coupler) k. Note that in MPS 330, each node represents a site. The index iₖ specifies the local state of qubit/coupler k, and the indices αₖ are referred to as “bond dimensions” or “virtual indices,” which represent the entanglement between adjacent qubits/couplers. Each

$${M}_{k}^{{i}_{k}}$$

is a matrix of dimensions Dₖ₋₁×Dₖ, where Dₖ is the bond dimension between site k and site k+1. The maximum bond dimension 332, typically denoted by χ, determines the maximum entanglement that can be represented by the MPS 330 and also governs the computational cost of operations on the MPS 330.

This factorization is particularly powerful for systems with local interactions or those that are low-entanglement. By limiting the bond dimension, the number of parameters needed to describe the state scales polynomially with the number of sites, rather than exponentially. This makes MPS 330 a widely used numerical tool for simulating one-dimensional quantum systems (e.g., see FIG. 4), allowing for efficient computation of eigenstates/eigenvalues, time evolution, and expectation values of local observables. Note that the memory required to store the wavelength tensor 320 representation scales as [symbol] (d^{N}), where d is the number of eigenstates for a single site, while the memory required to store the matrix product state 500 representation scales as [symbol] (Nχd). Thus, the MPS representation provides a dramatic reduction in the required memory. FIG. 4 shows an example of representing a 2D device as a 1D spin chain 400, according to various embodiments. That is, FIG. 4, a 2D layout (e.g., device layout 200 of FIG. 2B) has been “unraveled” into a 1D chain of qubits and couplers (e.g., a 1D spin chain).

### Matrix Product States and DMRG Algorithms

As discussed in conjunction with FIG. 3B, a low-energy wavefunction of a one-dimensional gapped local Hamiltonian A on Ĥ sites (e.g., device Hamiltonian 220 of FIG. 2B) can be more efficiently approximately described by a matrix product state (MPS) (e.g., MPS 330 of FIG. 3B), |ψ [symbol] , mathematically expressed as:

$$\vert ψ 〉 = {\sum }_{{α}_{1} , … , {α}_{N}} C ( {B}_{[ 1 ]}^{{α}_{1}} … {B}_{[ N ]}^{{α}_{N}} ) \vert {α}_{1} … {α}_{N} 〉 \qquad ( 1 )$$

where B_{[x]} is a 3-index (or rank 3) MPS tensor on site x∈{1, 2, . . . , N} with complex components

$${( {B}_{[ x ]} )}_{{β}_{x - 1} {β}_{x}}^{α} .$$

The index αdenotes the physical degree of freedom α=1, . . . , d, while βₓ₋₁ and βₓ are the bond indices which run over βₓ=1, . . . , χₓ. The largest bond dimension max(χₓ)∀x∈{1, . . . , N} is referred to as the MPS bond dimension χ. C denotes contraction of the bond indices β connecting neighboring tensors.

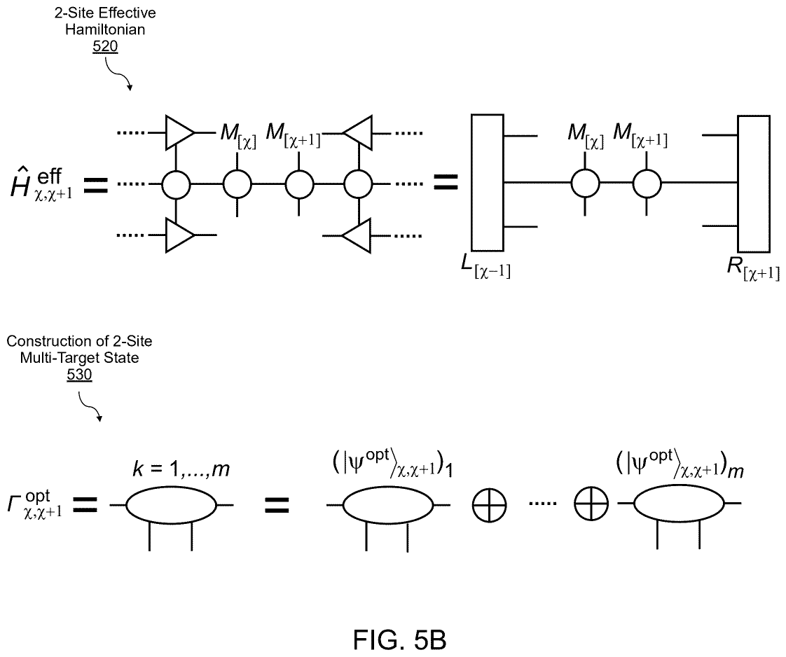

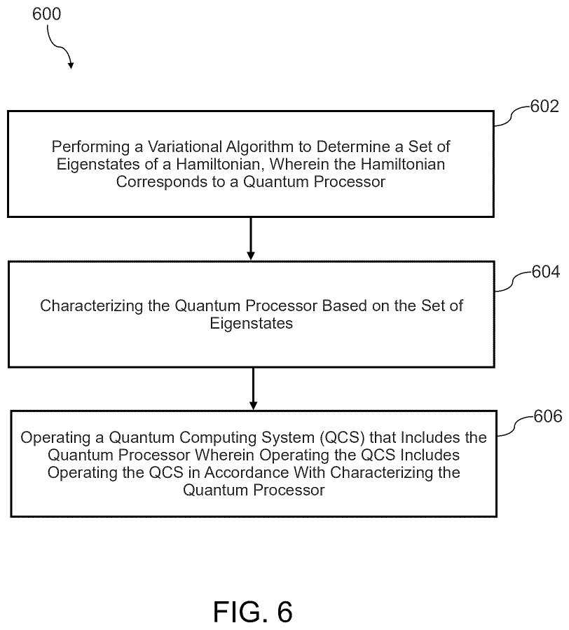

FIG. 5A shows a tensor network diagram depicting a multi-target matrix product state 500 and a tensor network diagram depicting an ansatz 510 for a density matrix renormalization group algorithm, according to various embodiments. The ansatz 510 can be expanded to represent m eigenstates by attaching an extra index k to the center of orthogonality tensor B_{[co]}. Diagrammatically this may be represented as a squiggly leg, as is shown in the ansatz 510. The state Γ is known as the multi-target MPS (MTMPS 500), and mathematically it is the direct sum of individual MPS at the excited leg index:

$$Γ = {{⊕}_{k = 1}}^{m} [ {\sum }_{{α}_{1} , ... , {α}_{N}} C ( {B}_{[ 1 ]}^{{α}_{1}} ... {( {B}_{[ co ]}^{{α}_{co}} )}^{k} ... {B}_{[ N ]}^{{α}_{N}} ) \vert {α}_{1} ... {α}_{N} 〉 ] \qquad ( 2 )$$

Both the standard MPS and the multi-target MPS ansatz can be efficiently optimized to approximately represent low energy eigenstates of a gapped local Hamiltonian Ĥ through the density matrix renormalization group (DMRG) algorithm. Firstly, the local Hamiltonian Ĥ may be decomposed into a product of N local matrix operators, whose two physical indices α, α′ run over d values respectively, acting on the physical degrees of freedom of the MPS. This is known as a matrix product operator (MPO). A DMRG algorithm begins with an initial MPS, which can be a random or informed guess. This is then optimized by performing consecutive two-site updates in right and left sweep.

FIG. 5B shows a tensor network diagram depicting a 2-site effective Hamiltonian 520 and a construction of a 2-site multi-target state 530, according to various embodiments. The 2-site effective Hamiltonian 520

$$( {\hat{H}}_{x , x + 1}^{eff} )$$

is on sites x, x+1. The construction of the 2-site multi-target state 530, is performed by taking the direct sum of optimized effective eigenstates of

$${\hat{H}}_{x , x + 1}^{eff}$$

520.

A two-site DMRG implementation includes four steps as follows:
(i) Consider two MPS contiguous site tensors B[x−1],B[x] and obtain the effective Hamiltonian on those two sites,

$${\hat{H}}_{x , x + 1}^{eff} ,$$

by projecting the MPO Hamiltonian onto a variational basis of dimension (χₓ₋₁, d, d, χₓ₊₁). This is done by transforming the MPS into a mixed canonical form centered on site x and projecting the MPO onto the bond indices Bₓ₋₁, Bₓ₊1, (e.g., see the 2-site effective Hamiltonian 520 of FIG. 5B).
ii) obtain the m eigenstates of interest from this effective two-site Hamiltonian. If m>1, combine into a multi-target two-site effective state through a direct sum (e.g., see the construction of the 2-site multi-target state 530 of FIG. 5B). Equation (3) provides the optimal tensor to replace B_{[x-1]} and B_{[x]} given the state of the rest of the chain.

$${{{{{Γ}_{x , x + 1}^{opt} = ⊕ ( \vert {ψ}^{opt} 〉}_{x , x + 1} )}_{k}}_{k = 1}}^{m} \qquad ( 3 )$$

iii) Recover the MPS form by performing a singular value decomposition of the two-site effective tensor.
iv) Shift the optimization x−1, x by one site to continue with the DMRG sweep. Shift to x, x+1 or x−2, x−1 for a right and left sweep respective.

The DMRG is finalized when the total energy measured from the MPS has converged. The accuracy of the final wavefunction depends on the value of the bond dimension χ. To assess the accuracy of an eigenstate obtained through DMRG we may use the variance of the Hamiltonian expectation value:

$$var ( \hat{H} ) = {〈 {ψ}^{MPS} \vert \hat{H} \vert {ψ}^{MPS} 〉}^{2} - 〈 {ψ}^{MPS} \vert {\hat{H}}^{2} \vert {ψ}^{MPS} 〉 \qquad ( 4 )$$

### DMRG Variants

The different variants of the DMRG algorithm depend on the criterion used to select optimal eigenstates from the two-site effective Hamiltonian

$${\hat{H}}_{x , x + 1}^{eff}$$

in step ii) above. In one DMRG formulation (e.g., groundstate DMRG) used by some embodiments, only the lowest energy eigenstate of said operator is kept, leading to the MPS of the groundstate of Ĥ at convergence. In the multi-target DMRG approach (as employed by some embodiments), the lowest m energy eigenstates are combined to form

$${Γ}_{x , x + 1}^{opt}$$

and the resulting converged state is a multi-target MPS (e.g., MTMPS 500 of FIG. 5A) of the lowest m eigenstates of Ĥ. Obtaining several eigenstates at once through the multi-target DMRG (MTDMRG) offers a more uniform and efficient convergence across all eigenstates compared to sequentially obtaining the excited states through a groundstate DMRG with lower eigenstate projection. In this case the m^{th} excited eigenstate is found by running the groundstate DMRG with a modified matrix product operator (MPO) Hamiltonian Ĥ′(m) after projecting out all the lower energy states.

$${\hat{H}}^{′ ( m )} = ( 𝕝 - {\sum }_{j = 1}^{m - 1} \vert {ψ}_{j} 〉 〈 {ψ}_{j} \vert ) \hat{H} ( 𝕝 - {\sum }_{j = 1}^{m - 1} \vert {ψ}_{j} 〉 〈 {ψ}_{j} \vert ) \qquad ( 5 )$$

### DMRG-X: Targeting Single States

One drawback of the groundstate DMRG and MTDMRG methods for finding excited states is that one cannot target a particular state of interest, and one may be forced to find all eigenstates with energy lower than the targeted state. In systems that display strong many-body localization (MBL), some embodiments employ another DMRG-variant to target excited eigenstates. The energy spacing between excited states in MBL systems is ~ [symbol] (1/N), which makes directly targeting an excited energy inefficient. However, some embodiments leverage the localized spatial structure of the excitations in these systems. Some embodiments employ a method to target excited MBL eigenstates. This excited state DMRG-variant algorithm is referred to as DMRG-X. The DMRG-X algorithm comes in two flavors: one that targets a single excited state (referred to as simply DMRG-X) and another that targets multi-excited states (referred to as multi-target DMRG-X (MTDMRG-X)). This section concentrates on the single-target DMRG-X algorithm and the next section discusses the MTDMRG-X algorithm.

The DMRG-X algorithm (as used by some embodiments) targets excited states through their spatial profile. Using this DMRG-variant, the embodiments obtain highly excited eigenstates of MBL Hamiltonians, known to display area law of entanglement. In short, the DMRG-X procedure introduces a new criterion for selecting eigenstates of the effective two-site Hamiltonian according to their spatial structure. The variational MPS is initialized to be the product state closest in overlap to the target state. The optimal two-site state |ψ^{opt} [symbol] _{x,x+1} in step ii) (of the above steps of a generalized DMRG algorithm). The construction of the 2-site multi-target state 530 of FIG. 5B is defined to be the eigenstate of

$${\hat{H}}_{x , x + 1}^{eff}$$

with largest overlap with the current variational MPS at each update. Some embodiments implement the DMRG-X algorithm by fully diagonalizing

$${\hat{H}}_{x , x + 1}^{eff}$$

with an incurred cost of [symbol] ~χ⁶.

### Multi-Target DMRG-X

The multi-target DMRG-X algorithm (as employed by some of the embodiments) extends the DMRG-X method by utilizing the multi-target MPS ansatz with a two-site update rule where the overlap with a set of product states is maximized. As mentioned above, this DMRG-variant is referred to as multi-target DMRG-X (MTDMRG-X). A crucial advantage of this method with respects to the single-target DMRG-X is the efficient simultaneous resolution of strongly resonant states, where a set of wavefunctions have almost equal projection onto the same bare states (e.g. ψ±~|01 [symbol] ±|10 [symbol] ). These type of hybridized states are relevant in cQED for investigating effects such as cross-talk or state-dependent avoided crossings. The original DMRG-X formulation can miss states and requires running separate instances with a new Hamiltonian that projects out the previously found states, which comes at an increased computational cost. The MTDMRG-X algorithm for targeting the set of m dressed states given a set S of reference (bare) states is addressed below. Equation (6) provides a representation of S.

$${{S = \{ \vert {b}_{1} 〉 , \vert {b}_{2} 〉 , … , \vert {b}_{m} 〉 \} where \vert {b}_{k} 〉 = ⊗ \vert {p}_{j} 〉 and {p}_{j} ∈ \{ 0 , … , d - 1 \}}_{j = 1}}^{N} \qquad ( 6 )$$

where N is the number of transmons and d is the number of bosonic levels of each transmon. It is noted that in some implementations of the embodiments, all the states in S are product (bare) states, but this may be generalized to any generic quantum state that is wanted to use as a reference bare state.

The steps of a MTDMRG-X algorithm are as follows:
i) Initialize the MPS ansatz by combining the product states in S into an MTMPS of bond dimension m, such that

$$\vert {ψ}_{0}^{MPS} 〉 = {⊕}_{i = 1}^{m} \vert {b}_{i} 〉 .$$

ii) Obtain the effective Hamiltonian

$${\hat{H}}_{x , x + 1}^{eff}$$

for updating sites x, x+1.
iii) Find the eigenstates of

$${\hat{H}}_{x , x + 1}^{eff}$$

sequentially (through a sparse method for efficiency). As each eigenstate is found, obtain its overlap with all product states in S projected onto the

$${\hat{H}}_{x , x + 1}^{eff}$$

variational subspace. Denote the projected bare state as |P_{b}_{ₖ} [symbol] . If the overlap squared with the projector is above a certain threshold, that eigenstate, |ψ^{opt} [symbol] _{x,x+1}, is matched with a bare state and stored to make up the optimal effective multi-target two-site state as in equation (3). This can be continued to find eigenstates of

$${\hat{H}}_{x , x + 1}^{eff}$$

until either all thee m states in S have been matched, or a cumulative overlap has been reached for all states in S (in which case the eigenstate with largest overlap is picked). It may be ensured that no eigenstate is matched with more than one target state. The two-site multi-target eigenstate may then be constructed (e.g., see the construction of the 2-site multi-target state 530 of FIG. 5B).

$${{{{{{{Γ}_{x , x + 1}^{opt} = ⊕ ( \vert {ψ}^{opt} 〉}_{x , x + 1} )}_{k}}_{k = 1}}^{m} where ( \vert {ψ}^{opt} 〉}_{x , x + 1} )}_{k} = arg max \vert {〈 {P}_{{b}_{k}} \vert ψ 〉}_{x , x + 1} \vert \qquad ( 7 )$$

If m is larger than the total dimension the resulting excited leg tensor can support, only the χₓ₋₁dχx lowest energy eigenstates are kept.
iv) Recover the MPS form through a singular value decomposition and shift update site.

This two-site update protocol is repeated until convergence is reached. In practice, the full set of reference states S for a strongly hybridized state might not be known. This issue may be solved by running MTDMRG-X using a set of states that we do know S′ (where S′⊆S). The converged MTMPS I will only contain a subset of all possible hybridized states. We compute the overlap with all product basis states in the system (which can be done efficiently) and find the full set S. This is a set of bare states such that the total overlap with T is above threshold, meaning that we have found most of the basis state support of the hybridized set of states. Explicitly:

$$S = \{ \vert {b}_{k} 〉 \} s . t . {\vert {⊕}_{k = 1}^{m} 〈 {b}_{k} \vert Γ 〉 \vert}^{2} > {t}_{h} \qquad ( 8 )$$

### Methods

FIG. 6 shows a flowchart for a method 600 for quantum computing, according to various embodiments. The quantum computing may be performed via a quantum computing system (QCC) that includes a quantum processor. The quantum processor may include a (1D or 2D) array of qubits and qubit couplers. The quantum computing system (QCS) may be similar to QCS of FIG. 100. Method 600 begins at block 602, where a variational algorithm is performed. An out to the performance of the variational method includes determining a set of eigenstates of a Hamiltonian. The Hamiltonian corresponds to the quantum processor. At block 604, the quantum processor is characterized based on the set of eigenstates. At block 606, a quantum computing system (QCS) that includes the quantum processor is operated in accordance with characterizing the quantum processor. In some embodiments, operating the QCS in accordance with characterizing the quantum processor includes implementing a quantum error correction (QEC) code in accordance with characterizing the quantum processor. In some embodiments, operating the QCS in accordance with characterizing the quantum processor includes measuring one or more qubits of the quantum processor while operating the QCS.

The variational algorithm may be a density-matrix-renormalization-group (DMRG) algorithm.

The DMRG algorithm may be a multi-target DMRG (MTDMRG) algorithm. The set of eigenstates may be a multi-target set of eigenstates. The MTDMRG algorithm may target the multi-target set of eigenstates.

The DMRG algorithm may be a DMRG-X algorithm that targets excited states of the Hamiltonian. The set of eigenstates may be a set of excited eigenstates of the Hamiltonian. The DMRG-X algorithm may target the set of excited eigenstates.

The Hamiltonian may be a many-body localization (MBL) Hamiltonian. The set of excited eigenstates may be a set of MBL states.

The DMRG algorithm may be a combination of a multi-target DMRG (MTDMRG) algorithm and a DMRG-X algorithm that targets excited states of the Hamiltonian.

Characterizing the quantum processor may include analyzing a design of the quantum processor based on the set of eigenstates.

Analyzing the design of the quantum processor may include analyzing coupler-mode delocalization in the design of the quantum processor.

Analyzing the design of the quantum processor may include simulating the design of the quantum processor.

Analyzing the design of the quantum processor may include charactering crosstalk and longer range couplings of a set of qubits and a set of couplers of the quantum processor.

Analyzing the design of the quantum processor may include identifying safe device-operation regimes of the quantum processor with low spectator errors.

Analyzing the design of the quantum processor may include mitigating errors of the quantum processor.

The quantum processor includes a set of qubits and a set of qubit couplers. The Hamiltonian includes a set of degrees of freedom (DOF) over the set of qubits and the set of qubit couplers.

The set of qubits may be arranged in a qubit array. The set of DOF may include a DOF over the qubit array

The qubit array may be a two-dimensional (2D) qubit array. The set of DOF may include DOFs over the 2D qubit array.

Performing the DMRG algorithm may include encoding at least a portion of the set of eigenstates in a matrix product state (MPS).

The DMRG algorithm may be performed via a classical processor device.

An ansatz corresponding to a set of bare states of the Hamiltonian may be an input to the DMRG algorithm. The output of the DMRG algorithm may be the set of eigenstates.

The set of eigenstates may be a set of dressed eigenstates of the Hamiltonian.

The quantum processor may include a set of quantum devices that includes a set of qubits and a set of qubit couplers. The Hamiltonian may include a sum over a set of single-site terms. Each single-site term of the set of single-site terms may correspond to a Kerr-oscillator model. The Kerr-oscillator model may model, in isolation, each qubit coupler of the set of qubit couplers and, in isolation, each qubit of the set of qubits.

The Hamiltonian may further include a sum over a set of interaction terms. Each interaction term of the set of interaction terms may correspond to an interaction between two or more quantum devices of the set of quantum devices.

Another embodiment includes a quantum computing system (QCS). The QCS includes a quantum processor that has been characterized via any of the methods discussed herein. For example, the quantum processor may have been characterized by determining a set of dressed eigenstates of a device Hamiltonian corresponding to the quantum processor. Determining the set of dressed eigenstates may include performing a variational algorithm (e.g., a DMRG algorithm or a DMRG-variant algorithm). The variational algorithm receives an ansatz as an input. For example, the ansatz may include bare eigenstates of the device Hamiltonian.

### ADDITIONAL EMBODIMENTS

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc..

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for quantum computing, the method comprising:
performing a variational algorithm to determine a set of eigenstates of a Hamiltonian, wherein the Hamiltonian corresponds to a quantum processor; and
characterizing the quantum processor based on the set of eigenstates.

2. The method of claim 1, wherein the variational algorithm is a density-matrix-renormalization-group (DMRG) algorithm.

3. The method of claim 2, wherein the DMRG algorithm is a multi-target DMRG (MTDMRG) algorithm, the set of eigenstates is a multi-target set of eigenstates, and the MTDMRG algorithm targets the multi-target set of eigenstates.

4. The method of claim 2, wherein the DMRG algorithm is a DMRG-X algorithm that targets excited states of the Hamiltonian, the set of eigenstates is a set of excited eigenstates of the Hamiltonian, and the DMRG-X algorithm targets the set of excited eigenstates.

5. The method of claim 4, wherein the Hamiltonian is a many-body localization (MBL) Hamiltonian and the set of excited eigenstates is a set of MBL states.

6. The method of claim 2, wherein the DMRG algorithm is a combination of a multi-target DMRG (MTDMRG) algorithm and a DMRG-X algorithm that targets excited states of the Hamiltonian.

7. The method of claim 1, wherein characterizing the quantum processor comprises:
analyzing a design of the quantum processor based on the set of eigenstates.

8. The method of claim 7, wherein analyzing the design of the quantum processor comprises:
analyzing coupler-mode delocalization in the design of the quantum processor.

9. The method of claim 7, wherein analyzing the design of the quantum processor comprises:
simulating the design of the quantum processor.

10. The method of claim 7, wherein analyzing the design of the quantum processor comprises at least one of:
charactering crosstalk and longer range couplings of a set of qubits and a set of couplers of the quantum processor;
identifying safe device-operation regimes of the quantum processor with low spectator errors;
mitigating errors of the quantum processor.

11. The method of claim 1, wherein the quantum processor includes a set of qubits and a set of qubit couplers, and the Hamiltonian includes a set of degrees of freedom (DOF) over the set of qubits and the set of qubit couplers.

12. The method of claim 11, wherein the set of qubits is arranged in a qubit array and the set of DOFs includes a DOF over the qubit array.

13. The method of claim 12, wherein the qubit array is a two-dimensional (2D) qubit array and the set of DOF includes DOFs over the 2D qubit array.

14. The method of claim 2, wherein performing the DMRG algorithm comprises:
encoding at least a portion of the set of eigenstates in a matrix product state (MPS).

15. The method of claim 2, wherein the DMRG algorithm is performed via a classical processor device.

16. The method of claim 2, wherein an ansatz corresponding to a set of bare states of the Hamiltonian is an input to the DMRG algorithm and an output of the DMRG algorithm is the set of eigenstates.

17. The method of claim 16, wherein the set of eigenstates is a set of dressed eigenstates of the Hamiltonian.

18. The method of claim 1, wherein the quantum processor includes a set of quantum devices that includes a set of qubits and a set of qubit couplers, the Hamiltonian includes a sum over a set of single-site terms, each single-site term of the set of single-site terms corresponds to a Kerr-oscillator model that models, in isolation, each qubit coupler of the set of qubit couplers and, in isolation, each qubit of the set of qubits.

19. The method of claim 18, wherein the Hamiltonian further includes a sum over a set of interaction terms and each interaction term of the set of interaction terms corresponds to an interaction between two or more quantum devices of the set of quantum devices.

20. The method of claim 1, the method further comprising:
operating a quantum computing system (QCS) that includes the quantum processor wherein operating the QCS includes operating the QCS in accordance with characterizing the quantum processor.

21. The method of claim 20, wherein operating the QCS further includes:
implementing a quantum error correction (QEC) code in accordance with characterizing the quantum processor.

22. The method of claim 20, wherein operating the QCS further includes:
measuring one or more qubits of the quantum processor while operating the QCS.

23. A quantum computing system (QCS) comprising:
a quantum processor that has been characterized via determining a set of dressed eigenstates of a device Hamiltonian corresponding to the quantum processor, and determining the set of dressed eigenstates includes performing a variational algorithm that receives an ansatz as an input.
